(19) United States
(12) Patent Application Publication
(10) Pub. No.: US 2006/0294471 A1
(43) Pub. Date: Dec. 28, 2006

(54) Method for data transfer

(76) Inventor: Terry K. Gilliam, North Kingstown, RI (US)

Correspondence Address: DEVINE, MILLIMET & BRANCH, P.A., 111 AMHERST STREET, BOX 719, MANCHESTER, NH, 03105, US

(21) Appl. No.: 11/454,056

(22) Filed: Jun. 15, 2006

Related U.S. Application Data
(60) Provisional application No. 60/690,684, filed on Jun. 15, 2005.

(51) Int. Cl. G06F 3/00; G06F 17/00

(52) U.S. Cl. 715/769; 715/513

(57) ABSTRACT

A method for dragging and dropping data from secondary html to primary html. The method includes the steps of selecting secondary html data in a first window; dragging the secondary html data to a second window; converting the secondary html data to primary html data; and saving the primary html data to the second window.

### CROSS-REFERENCE TO RELATED APPLICATIONS

The present application claims the benefit of U.S. Provisional Patent Application Ser. No. 60/690,684 filed Jun. 15, 2005, which is incorporated herein by reference.

### TECHNICAL FIELD

The present invention relates to data transfer and more particularly, to a drag and drop method for dragging and dropping data from secondary to primary html.

### BACKGROUND OF THE INVENTION

Presently, there is no method for dragging and dropping data from primary html to secondary html.

Accordingly, what is needed in the art is a method for dragging and dropping data from primary html to secondary html.

### SUMMARY

In accordance with one aspect of the present invention, a method for dragging and dropping data from secondary html to primary html is disclosed. The method includes the steps of selecting secondary html data in a first window; dragging the secondary html data to a second window; converting the secondary html data to primary html data; and saving the primary html data to the second window.

Some embodiments of this aspect of the present invention include one or more of the following. Determining whether the primary html data already exits in the second window. Assigning a first ID corresponding to the secondary html data to a first hidden control on the first window.

Assigning a second ID to a second hidden control on the first window corresponding to an ID value of the second window.

In accordance with another aspect of the present invention, a method for dragging and dropping data from secondary html to primary html is disclosed. The method includes selecting secondary html data in a first window and assigning a first ID corresponding to the secondary html data to a first hidden control on the window. Next, dragging the secondary html data to a second window. Then, converting the secondary html data to primary html data. Next, assigning a second ID to a second hidden control on the first window corresponding to an ID value of the second window. Next, determining whether the primary html data already exits in the second window. Finally, saving the primary html data to the second window.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIG. 1 is a schematic diagram of one embodiment of the present invention; and

FIG. 2 is a flow chart of one embodiment of the present invention.

### DETAILED DESCRIPTION OF THE PREFERRED EMBODIMENTS

The present invention is a method of dragging selected secondary html data in a first window, and dropping this data into a second window, converting the data into primary html data. The drag and drop data is selected and dragged from the Background card on the first window (“dragged item”). This drag action triggers a Javascript function called “fnHandleDrag”. The call to this function will reference the primary window from which the Background card was opened. It will set the value of a hidden control on the primary page to the ID value of the Dragged item (each item or input has its own unique ID, this identifies which input is being manipulated). The selected data is then dropped into a second window. This action triggers a Javascript function called “fnHandleDropCategories”. The call to this function sets the value of another hidden control on the first window to the ID value of the second window (each secondary window has its own unique ID).

This function, fnHandleDropCategories in Javascript, will call a built in web service called DragAndDropCategories. This web service will take as parameters the ID values which were set as a result of the Drag and Drop events. In some embodiments, the web service will call a function to check if this dragged input already exists in the secondary window.

In some embodiments, the return value of the web service will call another Javascript function which uses the return value of the web service. If the return value is false, an alert is returned indicating the input already exists in the second window and therefore will not be added again.

This is accomplished by using an automatic web service to check if any data has changed. If data has changed, the second window will undergo the appropriate changes. If not, no action will occur.

For the purposes of this description, the term “drag”refers to the action of selecting and moving specific data. The term “drop”refers to the final location where the data is dragged and then released.

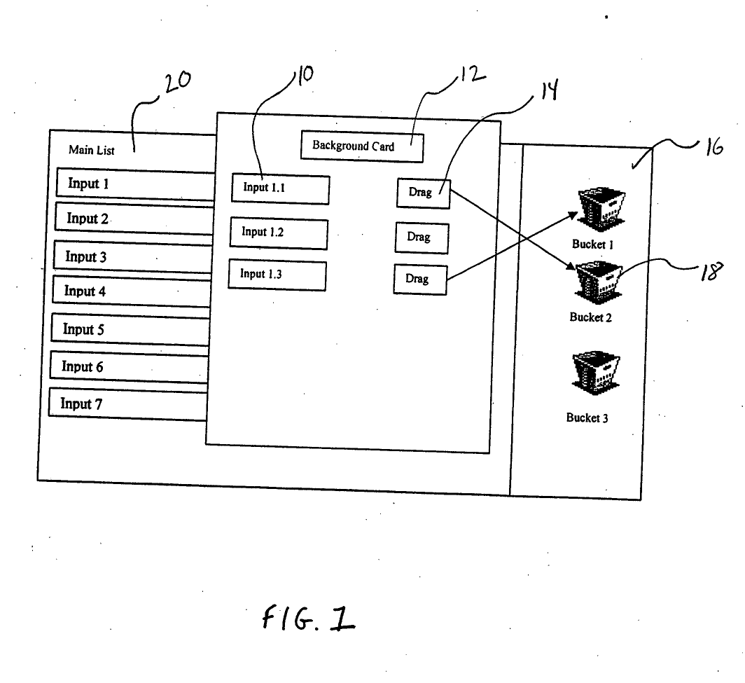

Referring now to FIG. 1, a schematic diagram of one embodiment of the invention is shown. Here, the input 10 is located on the background card 12. The input 10 is selected and dragged 14 to a second window 16. Here, the second window is in the form of a bucket 18. For example, the input 10 from the background card 12 contains comments for an offer or input on the main list 20. These comments on the background card 12 can be dragged and dropped on top of a bucket 18. This way the comment dragged will appear as an offer (that is, on the main list) of the bucket 18. Thus, the invention can be used as a means of categorization of input from one level to another through drag and drop.

In practice, the invention can be applied to web pages. In this embodiment, the primary page is referred to as AgendaItem.aspx. It is a web page built using ASP.Net. This page contains a section dedicated to showing user input. User inputs are continuously added to the page and therefore they need to be presented to the user on a non stop basis. To accomplish this, a hidden Javascript timer is placed on the AgendaItem.aspx page. On a specified time interval, this Javascript timer will call a web service which will retrieve all the related data from a SQL Server 2000 database. This related data contains input and user information. The web service is coded so that it returns this data in XML format. With each return of the data, the data will be stored in a session variable. The session variable will be compared against each new return to check if any changes have taken place since the last call to the web service. This web service sends its return values to the Javascript function from which it was called. Depending on the return value, another Javascript function will be called. In one embodiment, this function is referred to as Cb2. In another embodiment, the function has other names. In any case, the function, referred to as Cb2 in one embodiment, will check the return value of the web service, if it is the same as the previous value, then no change occurs to the page. Otherwise, the function will initiate an XSL transformer. The transformer will take the XML data and use a predefined XSL file to transform the data from XML to Html and display it to the user.

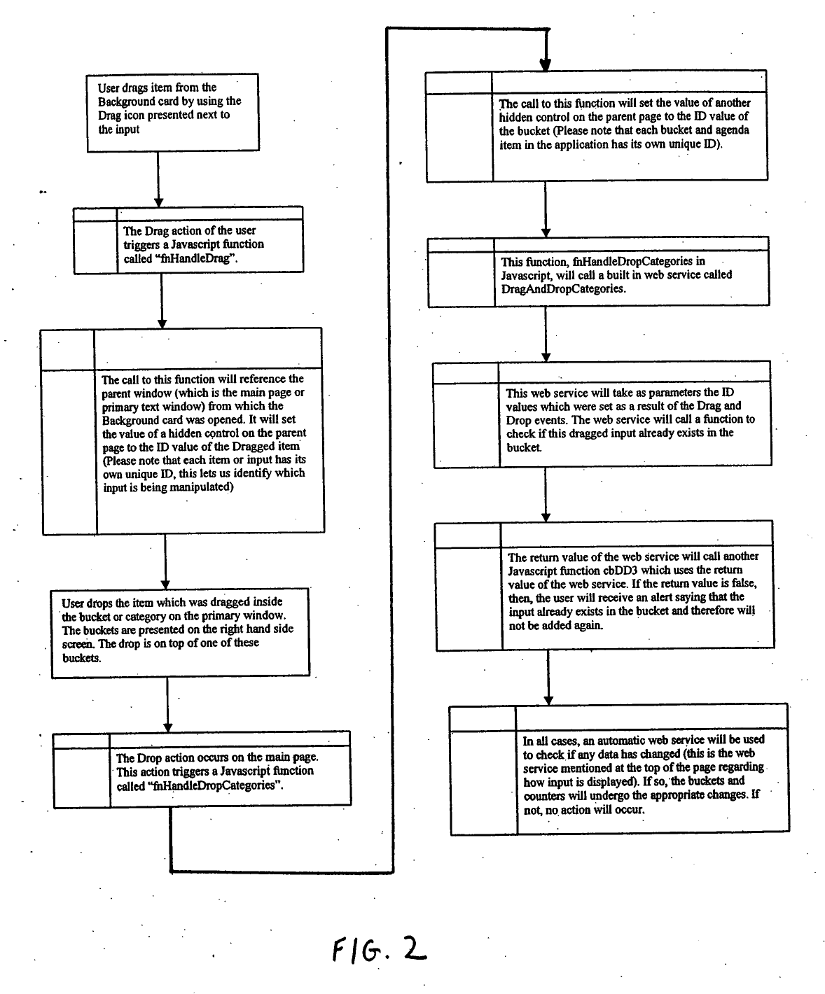

Referring now to FIG. 2, a flow chart of one embodiment of the method of the invention is shown. The flow chart presents a technical description of the drag and drop functionality for the embodiment described above.

Although the invention is described above with reference to particular embodiments, the invention is not limited to dragging and dropping from the “first window”to the “second window”. The embodiments above are meant to describe some, not all, embodiments of the present invention. The method applies to either window, i.e., data can be dragged from the second window and dropped into the first window. Thus, the invention is a method for dragging and dropping data from secondary html to primary html, irregardless of which window the data is located.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. A method for dragging and dropping data from secondary html to primary html, said method comprising the steps of:
selecting secondary html data in a first window;
dragging said secondary html data to a second window;
converting said secondary html data to primary html data; and
saving said primary html data to said second window.

2. The method of claim 1 further comprising determining whether said primary html data already exits in said second window.

3. The method of claim 1 further comprising assigning a first ID corresponding to said secondary html data to a first hidden control on said first window.

4. The method of claim 1 further comprising assigning a second ID to a second hidden control on said first window corresponding to an ID value of said second window.

5. A method for dragging and dropping data from secondary html to primary html, said method comprising the steps of:
selecting secondary html data in a first window;
assigning a first ID corresponding to said secondary html data to a first hidden control on said first window;
dragging said secondary html data to a second window;
converting said secondary html data to primary html data;
assigning a second ID to a second hidden control on said first window corresponding to an ID value of said second window;
determining whether said primary html data already exits in said second window; and
saving said primary html data to said second window.
